(19) United States
(12) Patent Application Publication
(10) Pub. No.: US 2025/0080889 A1
(43) Pub. Date: Mar. 6, 2025

(54) AUDIO OUTPUT DEVICE INCLUDING A MOUNTING ASSEMBLY

(71) Applicant: MILWAUKEE ELECTRIC TOOL CORPORATION, Brookfield, WI (US)

(72) Inventors: Jacob D. Hadfield, Mukwonago, WI (US); Matthew H. Ogden, Milwaukee, WI (US); Chelsea L. McCormick, Oak Creek, WI (US)

(21) Appl. No.: 18/820,406

(22) Filed: Aug. 30, 2024

Related U.S. Application Data
(60) Provisional application No. 63/579,531, filed on Aug. 30, 2023.

(51) Int. Cl. H04R 1/02

(52) U.S. Cl. CPC H04R 1/026

(57) ABSTRACT

An audio output device includes a housing, a speaker supported by the housing, and a battery receptacle supported by the housing and electrically coupled to the speaker. The battery receptacle is configured to receive a battery pack. The audio output device also includes a handle coupled to the housing and having a flange. The flange is configured to engage an external apparatus to hang the audio output device from the external apparatus.

### CROSS-REFERENCE TO RELATED APPLICATION

This application claims priority to U.S. Provisional Patent Application No. 63/579,531, filed Aug. 30, 2023, the entire contents of which are incorporated herein by reference.

### FIELD OF THE INVENTION

The present invention relates to an audio output device and, more particularly, to a mounting assembly for an audio output device.

### SUMMARY OF THE INVENTION

The present invention provides, in one aspect, an audio output device. The audio output device includes a housing, a speaker supported by the housing, and a battery receptacle supported by the housing and electrically coupled to the speaker. The battery receptacle is configured to receive a battery pack. The audio output device also includes a handle coupled to the housing and having a flange. The flange is configured to engage an external apparatus to hang the audio output device from the external apparatus.

The present invention provides, in yet another aspect, an audio output device. The audio output device includes a housing, a speaker supported by the housing, and a battery receptacle supported by the housing and electrically coupled to the speaker. The battery receptacle is configured to receive a battery pack. The audio output device also includes a flange extending from the housing. The audio output device includes a carabiner assembly coupled to the housing. The carabiner assembly includes an arm movable between a first position, in which an end of the arm engages the flange, and a second position, in which the end of the arm is spaced apart from the flange.

The present invention provides, in yet another aspect, an audio output device. The audio output device includes a housing a top, a base, a front, a back, and two sides. The housing includes a speaker grill extending partially between the top and the front of the housing. The audio output device includes a speaker supported by the housing, and a battery receptacle supported by the housing and electrically coupled to the speaker. The battery receptacle is configured to receive a battery pack. The audio output device also includes a handle coupled to the housing and extending between the two sides of the housing. The handle includes a first flange extending toward the base and a second flange spaced apart from the first flange and extending toward the base, the first and second flanges configured to engage an external apparatus to hang the audio output device from the external apparatus. The flange includes a carabiner assembly coupled to the housing. The carabiner assembly includes an arm having a first end and a second end opposite the first end, the arm being movable between a first position, in which an end of the arm engages the flange, and a second position, in which the first end is spaced apart from the first flange and the second end is spaced apart from the second flange. The carabiner assembly includes a spring coupled to the arm to bias the arm toward the first position.

### BRIEF DESCRIPTION OF THE DRAWINGS

FIG. 1 is a front perspective view of an audio output device.

FIG. 2 is a top view of the audio output device.

FIG. 3 is a front perspective view of the audio output device with a speaker grill removed, illustrating a speaker within the audio output device.

FIG. 4 is a rear perspective view of the audio output device, the audio output device including a carabiner assembly.

FIG. 5 is a side view of the audio output device.

FIG. 6 is a cross-sectional view of the audio output device.

FIG. 7 is a rear perspective view of part of the audio output device with portions removed.

FIG. 8 is a top view of the audio output device with portions removed.

FIG. 9A is a perspective view of the carabiner assembly in a closed position.

FIG. 9B is a perspective view of the carabiner assembly in an open position.

FIG. 10 is a perspective view of the audio output device mounted to a cart.

FIG. 11A is a side view of the audio output device with a rope threaded through a handle.

FIG. 11B is a side view of the audio output device with a rope threaded through the carabiner assembly.

FIG. 12 is schematic of the audio output device communicating with an external device and other audio output devices.

FIG. 13 is a block diagram illustrating the audio output device.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

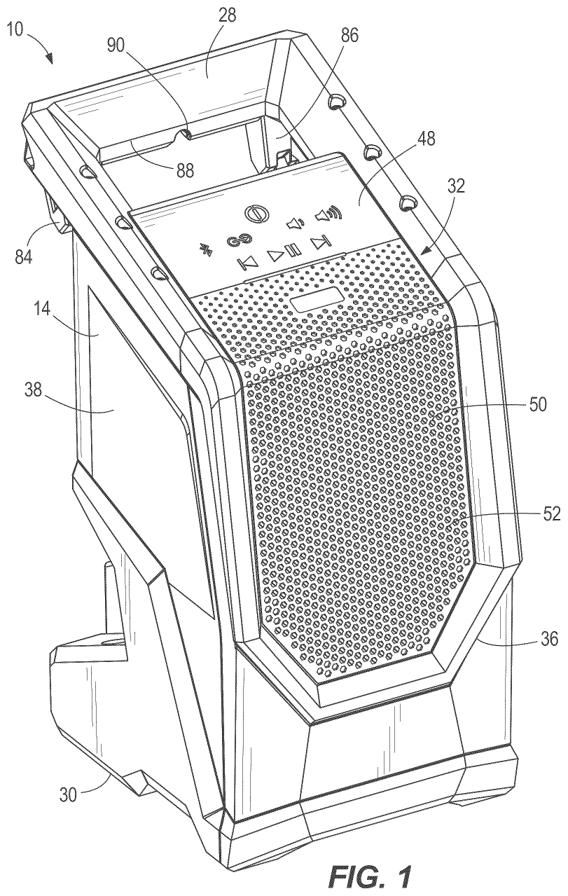

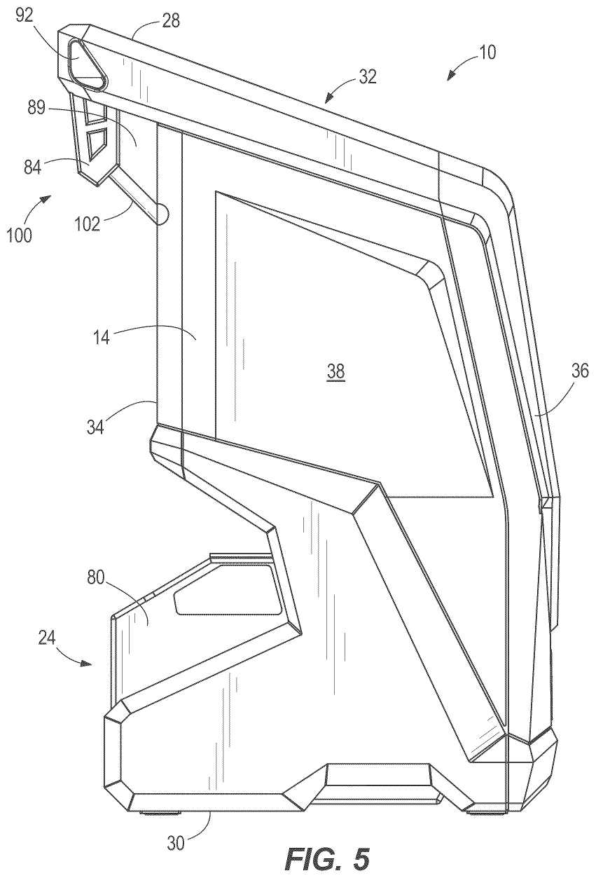

FIGS. 1-5 illustrate an audio output device 10. The illustrated audio output device 10 is a compact wireless device that can be carried to and from various locations, such as a jobsite. The audio output device 10 may receive audio signals from an external device (e.g., a user's smartphone) to play music or other audio. The audio output device 10 may also transmit audio signals to other audio output devices, creating a daisy-chain of audio output devices that enhance the output audio.

In the illustrated embodiment, the audio output device 10 includes a housing 14, one or more speakers 20, a battery receptacle 24, and a handle 28. The audio output device 10 also includes a mounting assembly for releasably mounting the audio output device 10 on various external structures.

The illustrated housing 14 is an irregular cuboid shape with a base 30, a top 32, a back 34, a front 36, and two sides 38, 40 extending between the top 32 and base 30. The housing 14 may be constructed of plastic or other durable material. In the illustrated embodiment, the base 30 of the housing 14 is configured to include thicker material than the rest of the housing 14. The base 30 is configured to support the audio output device 10 on a surface, such as a benchtop or floor. The housing 14 includes a speaker grill 50 located on the front 36 of the housing 14. The speaker grill 50 defines a plurality of apertures 52 that allows sound to be emitted from the speakers 20 while still protecting the speakers 20. In the illustrated embodiment, speaker grill 50 also extends partially over the top 32 and the front 36 of the housing 14. The housing 14 also includes an exhaust grill 44 located on the back 34 of the housing 14. The exhaust grill 44 facilitates cooling to the electrical components within the housing 14.

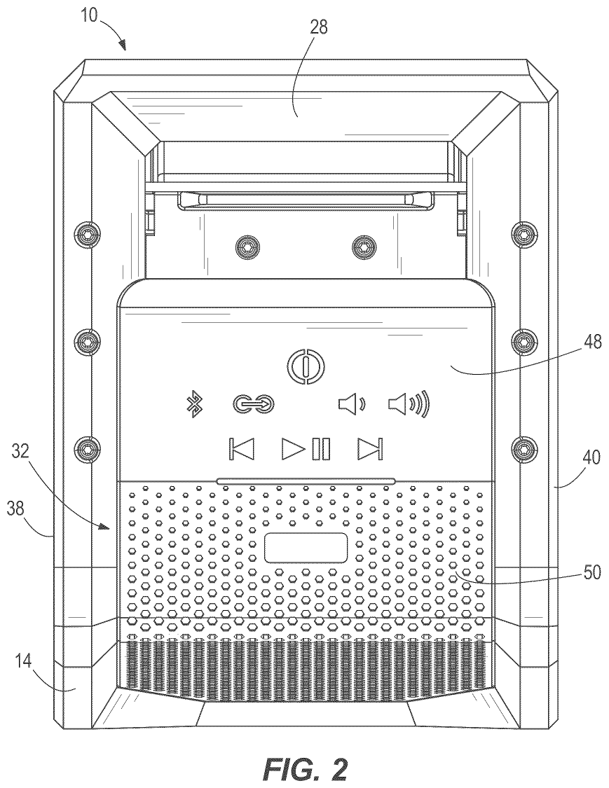

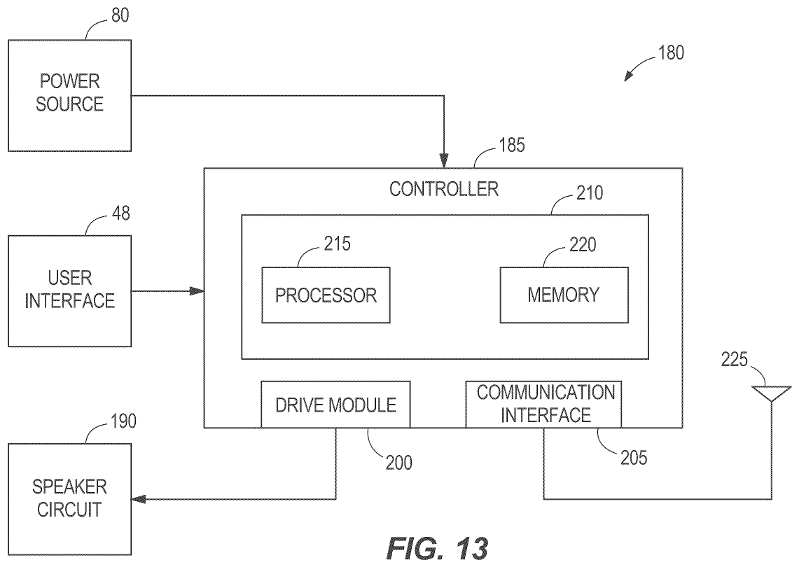

Referring to FIG. 2, the housing 14 includes a user interface. In the illustrated embodiment, the user interface is a control panel 48. The illustrated control panel 48 is located on the top 32 of the housing 14. In other embodiments, the control panel 48 may be located elsewhere on the housing 14 or the control panel 48 may be remote from the housing 14. The control panel 48 is in communication with a controller 185 (FIG. 13) and other electrical components within the housing 14 to control the operation of the speakers 20. The control panel 48 includes a plurality of actuators and plurality of indicators. The actuators may be capacitive touch buttons, physical buttons, dials, switches, sliders, and the like. The indicators may include light, such as LEDs, showing through various graphics or designs in the control panel 48. In some embodiments, the actuators allow users to perform various audio functions (play/pause, skip/rewind, adjust volume, etc.), as well as speaker functions (On/Off, Bluetooth pair, Daisy Chain, etc.). Indicators may symbolize various modes and/or statuses of the audio output device 10. In some embodiments, the control panel 48 may include a display for displaying one or more parameters of the speaker 20. In other examples, the display may be a touch screen display allowing for user inputs to be provided via the display.

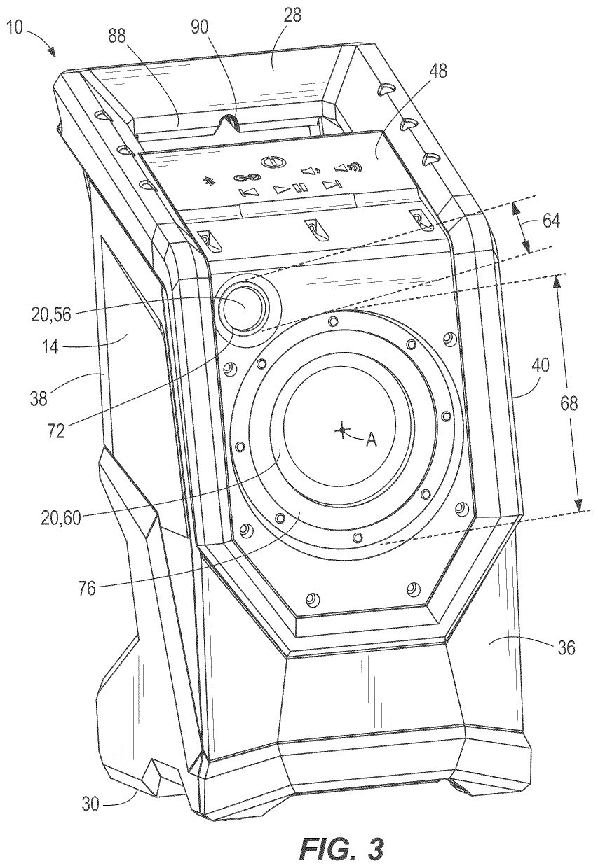

Referring to FIG. 3, the speakers 20 are supported by the housing 14. In the illustrated embodiment, the audio output device 10 include two speakers (i.e., a first speaker and a second speaker). The first speaker is a tweeter 56. The second speaker is a woofer 60. In other embodiments, the audio output device 10 may include fewer or more speakers 20 and/or different types of speakers 20. For example, the audio output device 10 may include a mid-range speaker, a subwoofer, a supertweeter, multiple tweeters 56, and/or may not include the woofer 60. The illustrated woofer 60 is located near a center A of the front 36 of the housing 14. The tweeter 56 is located near the woofer 60 on the front 36 of the housing 14. In particular, the tweeter 56 is located above, but offset from a vertical centerline of the woofer 60. The tweeter 56 includes a tweeter cone 72 that is aligned or flush with the front 36 of the housing 14. Similar, the woofer 60 includes a woofer cone 76 that is aligned or flush with the front 36 of the housing 14. The tweeter cone 72 has a first diameter 64. The woofer cone 76 has a second diameter 68 that is different than the first diameter 64. In the illustrated embodiment, second diameter 68 of the woofer cone 76 is larger than the first diameter 64 of the tweeter cone 72. In other embodiments, the speakers 20 may have other relative sizes and/or positioning. The speaker grill 50 covers the tweeter 56 and woofer 60 to inhibit debris from contacting the speakers 20.

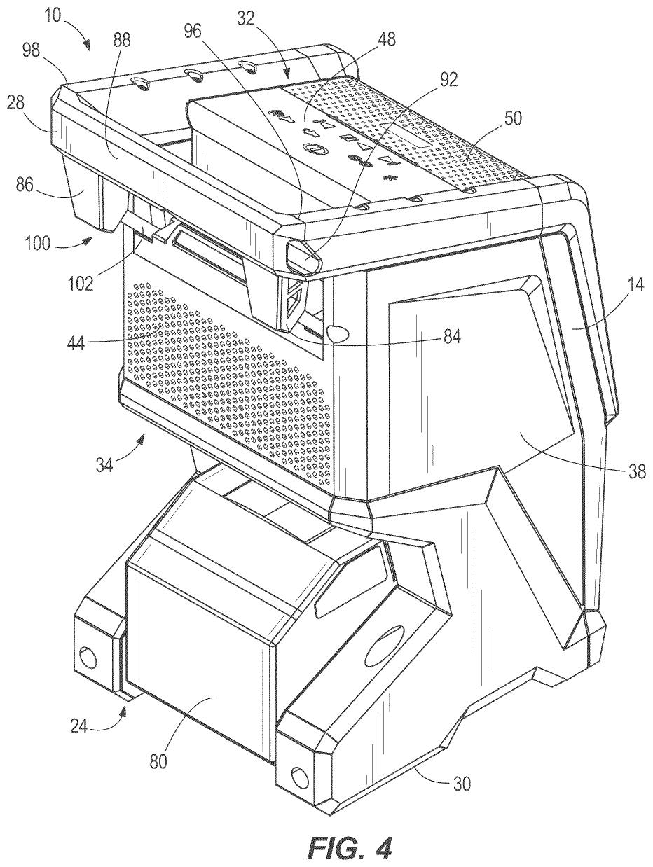

With reference to FIG. 4, the battery receptacle 24 is located on the back 34 of the housing 14. In the illustrated embodiment, the battery receptacle 24 is located adjacent the base 30 and below the exhaust grill 44. In other embodiments, the battery receptacle 24 may be located elsewhere on the housing 14. The battery receptacle 24 is electrically coupled to the speaker 20 and configured to receive a battery pack 80 or other power source. The battery pack 80 may be, for example, a power tool battery pack, such as a rechargeable 18 volt Li-ion battery pack. As such, the battery receptacle 24 may include electrical contacts and other structures (e.g., guide rails, etc.) to electrically and physically secure the battery pack 80 to the battery receptacle 24. In other embodiments, the battery receptacle 24 may receive other types of battery packs. In still other embodiments, the battery receptacle 24 may be internal to the housing 14. Additionally or alternatively, the battery pack 80 may be a dedicated battery pack that is rechargeable, but not removable from the housing 14.

With reference to FIG. 4, the handle 28 extends outwardly from the housing 14 to facilitate carrying the audio output device 10. The illustrated handle 28 is located near the top 32 of the housing 14 adjacent to the back 34. In the illustrated construction, the handle 28 extends parallel to the top 32 of the housing 14. In the illustrated constriction, the handle 28 extends between the two sides 38, 40. The handle 28 is also flush with the top 32 of the housing 14 to appear as a continuous piece that frames part of the speaker grill 50 and the control panel 48. In particular, the handle 28 is integrally formed with other parts of the housing 14. In other constructions, the handle 28 may be arranged elsewhere on the housing 14 and/or may be a separate piece that is permanently or removably coupled to the housing 14.

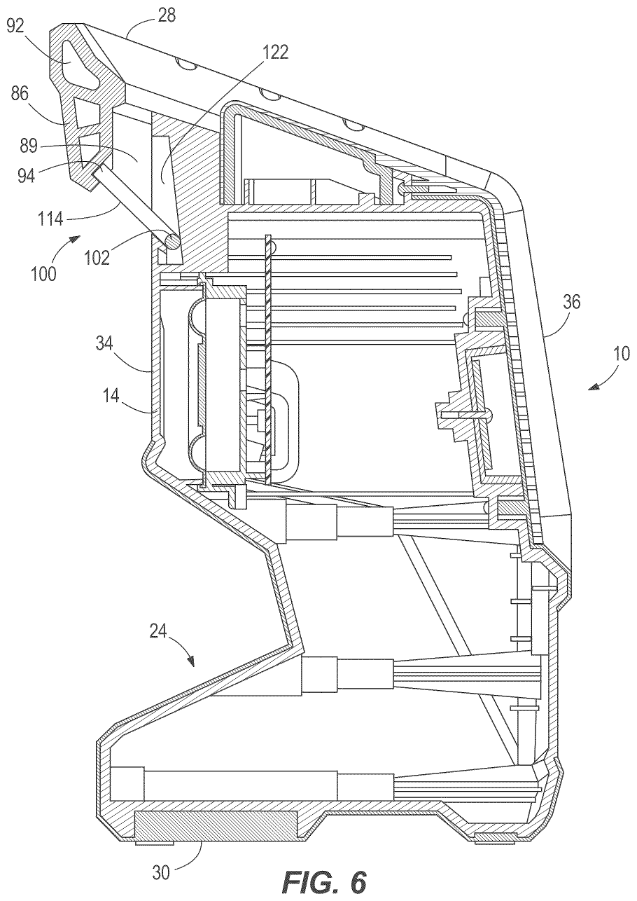

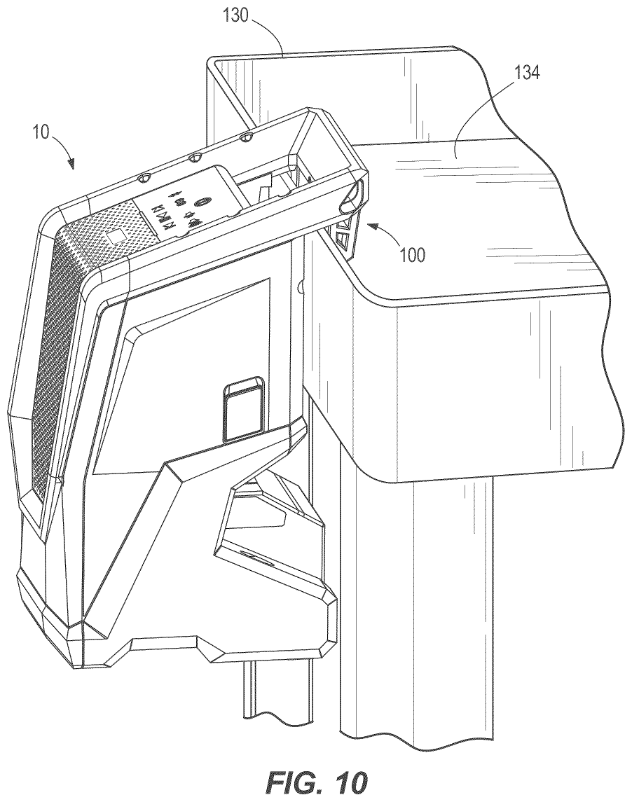

The illustrated handle 28 includes a pair of flanges 84, 86 (e.g., a first flange and a second flange) and a grip 88. The grip 88 is configured to be grasped by a user to carry the audio output device 10. The grip 88 extends between the sides 38, 40 of the housing 14, parallel to the back 34 and front 36 of the housing 14. The flanges 84, 86 are located on opposite ends of the grip 88. For example, the first flange 84 is located on a first corner 96 of the handle 28, and the second flange 86 is located on a second corner 98 of the handle 28. The flanges 84, 86 extend downwardly from the handle 28 (i.e., toward the base 30 of the housing 14 from the grip 88). In the illustrated embodiment, the flanges 84, 86 taper as they extend away from the grip 88. That is, the flanges 84, 86 decrease in cross-sectional area as they extend away from the grip 88. In other embodiments, the flanges 84, 86 may not taper or may have different shapes. Each flange 84, 86 also defines a flange recess 94 (FIG. 6). In the illustrated embodiment, the flanges 84, 86 are integrated with the handle 28. In other words, the flanges 84, 86 and the handle 28 are formed together in a monolithic construction. In the illustrated embodiment, the handle 28 and the flanges 84, 86 define a space 89 to receive an external apparatus to hang the audio output device 10 from the external apparatus (FIGS. 6 and 10). In the illustrated embodiment, the flanges 84, 86 are identical in construction. In some embodiments, the flanges 84, 86 are mirrored about a longitudinal plane that bisects the audio output device 10.

In some constructions, the audio output device 10 does not include a handle. Rather, the pair of flanges 84, 86 extend from the from the top 32 of the housing 14 with each flange 84, 86 forming an upside down “L” shape when viewed from a side of the audio output device 10 (e.g., viewed from the side 38). In some embodiments, the audio output device 10 includes a single flange. For instance, the audio output device 10 may include a single flange selected from the pair of flanges 84, 86. In some embodiments, the flange selected from the pair of flanges 84, 86 is located near the center of the handle 28.

The illustrated handle 28 also includes a hook recess 90 (FIG. 3). The hook recess 90 is located near the center of the grip 88. In other words, the hook recess 90 is disposed at a center of the handle 28 between the sides 38, 40. The hook recess 90 has a suitable size (e.g., diameter) for receiving a mounting fastener, such as a nail, screw, push pin, hook, etc. As such, the audio output device 10 can hang from a wall or other vertical structure using the hook recess 90 and a suitable mounting fastener. In other embodiments, the hook recess 90 may be located elsewhere on the handle 28 or the housing 14, or may be omitted.

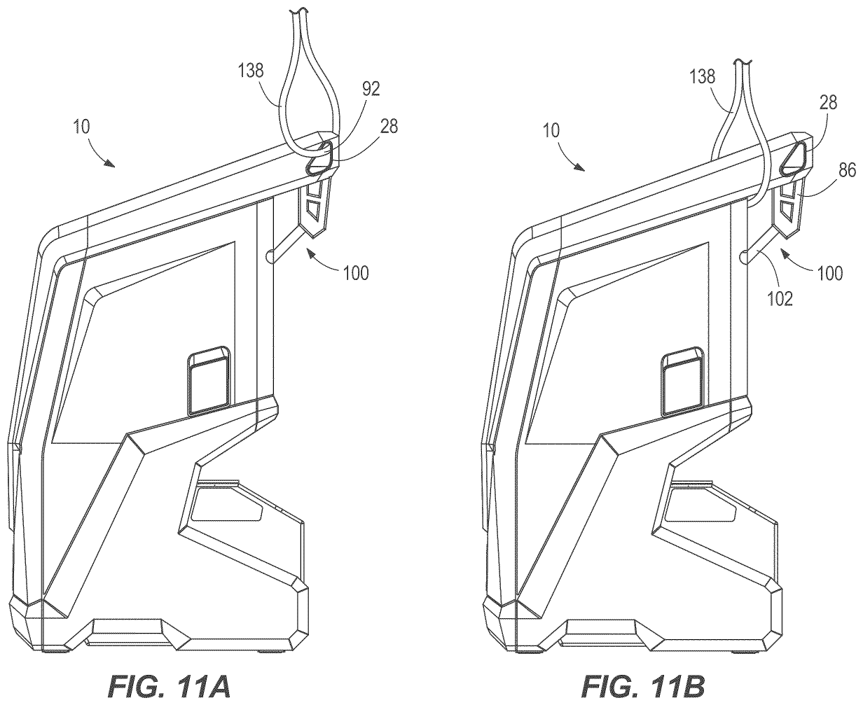

The illustrated handle 28 additionally includes an aperture 92. The aperture 92 is a bore extending through the grip 88. In particular, the aperture 92 is a continuous bore that extends a width of the handle 28. The aperture 92 is configured to receive a rope, or other suitable member, to hang the audio output device 10, as discussed below with reference to FIG. 11A. In other embodiments, the aperture 92 may be located elsewhere on the handle 28 or the housing 14, or may be omitted.

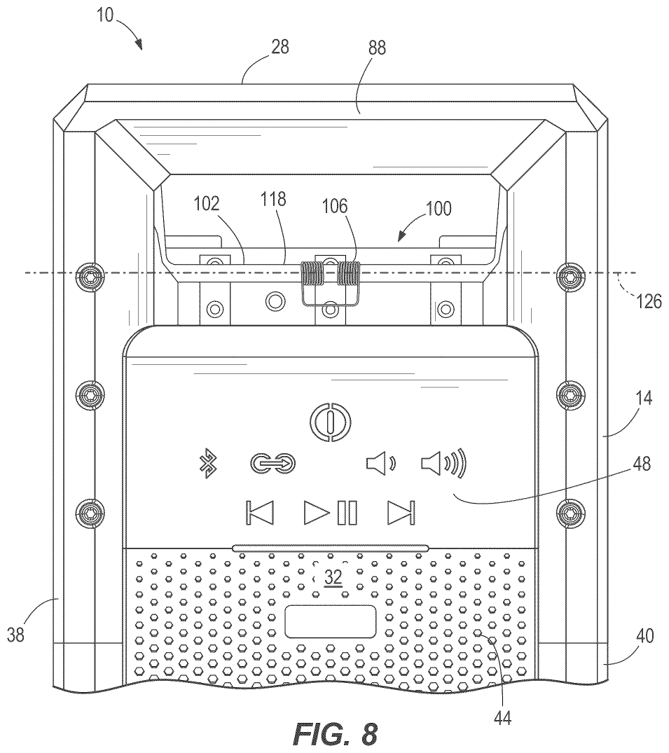

Referring to FIGS. 4-8, the mounting assembly can be used to mount the audio output device 10 to various external apparatuses (e.g., cart, table, shelf, chair, beam, etc.). In the illustrated embodiment, the mounting assembly is a carabiner assembly 100. The carabiner assembly 100 is located near the handle 28. In particular, the carabiner assembly 100 is located partially within the back 34 of the housing 14 below the handle 28. The illustrated carabiner assembly 100 includes an arm 102 and a spring 106. The arm 102 may also be referred to as a gate. In the illustrated embodiment, the arm 102 is an elongated member, such as an elongated rod, having a first end 110 and a second end 114 opposite the first end 110. The arm 102 also includes a central portion 118 extending between the first and second ends 110, 114. The central portion is located within the housing 14 and extends between the sides 38, 40 of the housing 14. The first and second ends 110, 114 are bent or angled relative to the central portion 118. In the illustrated embodiment, the first and second ends 110, 114 are angled approximately 90 degrees relative to the central portion 118. In other embodiments, the first and second ends 110, 114 may be angled by greater or lesser amounts relative to the central portion 118. In the illustrated embodiment, the first and second ends 110, 114 are parallel to each other. In other embodiments, the first and second ends 110, 114 may be angled offset to each other (e.g., the first and second ends 110, 114 each include a different angle relative to the central portion 118). The ends 110, 114 are configured to selectively engage the flanges 84, 86 of the handle 28. The arm 102, thereby, helps support the durability of the handle 28 and the flanges 84, 86 if, for example, the audio output device 10 is dropped. Although the illustrated arm 102 includes two ends 110, 114 that are bent relative to the central portion 118, in other embodiments, the arm 102 may only include one end and the handle 28 may only include one flange. Alternatively, in some embodiments, the ends 110, 114 of the arm 102 may be separate pieces that are not connected together by the central portion 118.

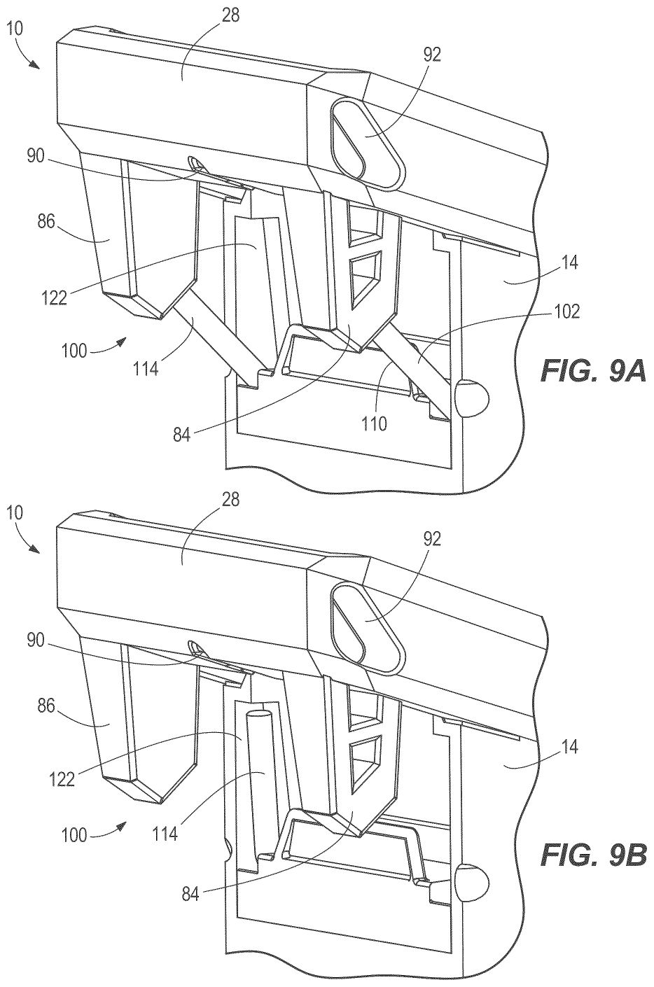

The arm 102 is movable relative to the housing 14 and the handle 28 between a first position (FIG. 9A), in which the ends 110, 114 of the arm 102 engage the flanges 84, 86, and a second position (FIG. 9B), in which the ends 110, 114 of the arm 102 are spaced apart from the flanges 84, 86. The first position may also be referred to as a closed position. The second position may also be referred to as an open position. When in the first position, the ends 110, 114 of the arm 102 are at least partially received in the flange recesses 94 (FIG. 6) of the flanges 84, 86. In this position, the housing 14, the handle 28, and the arm 102 form a closed loop. When in the second position, the ends 110, 114 of the arm 102 are moved out of flange recesses 94. In a furthest open position, the ends 110, 114 of the arm 102 may be received in housing recesses 122 (FIGS. 6 and 9B) formed in the housing 14. However, any intermediary position between the first position and the furthest open position may be considered the second, or open, position. In the illustrated embodiment, the ends 110, 114 of the arm 102 pivot between the first and second positions. In particular, the ends 110, 114 of the arm 102 pivot with the central portion 118 about a longitudinal axis 126 of the central portion 118 between the first and second positions. In other embodiments, the ends 110, 114 of the arm 102 may move in other ways between the first and second positions, such as linearly slide (e.g., retract and extend) into and out of the housing 14, or telescope. In the illustrated embodiment, the ends 110, 114 of the arm 102 move together between the first and second positions. In other embodiments, the ends 110, 114 of the arms 102 may move independently of each other relative to the first and second positions.

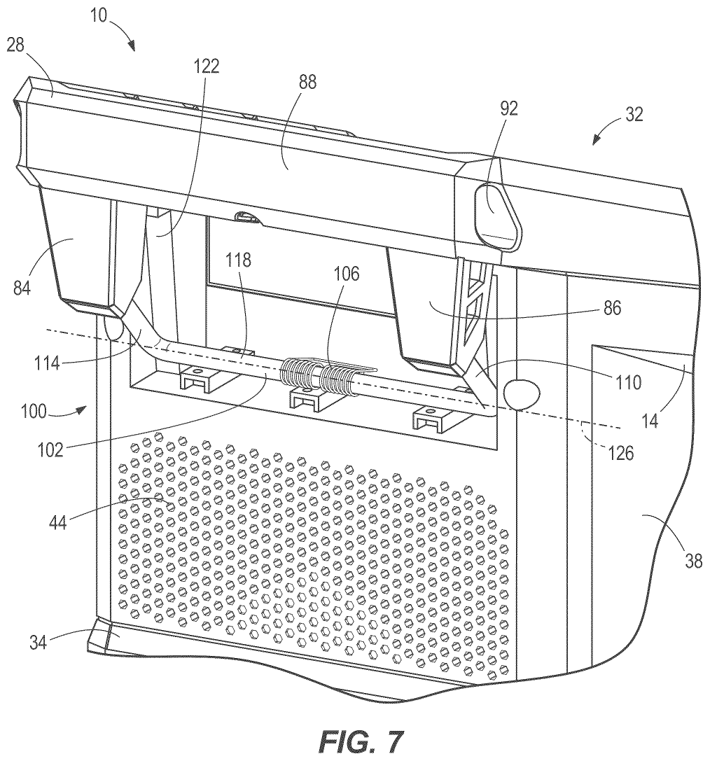

Referring back to FIG. 7, the spring 106 is coupled to the arm 102 to bias the arm 102 toward the first position. A user may apply a force to either or both ends 110, 114 of the arm 102 to overcome the spring 106 and move the arm 102 from the first position to the second position. The spring 106 may be, for example, a torsion spring. The torsion spring may be coiled around a portion of the arm 102 (e.g., the central portion 118) and engage surfaces of the housing 14 to bias the arm 102 toward the first position. In other embodiments, the spring 106 may be other suitable types of biasing members. In some embodiments, the carabiner assembly 100 may include multiple springs. In still other embodiments, the spring 106 may be omitted, and the arm 102 may be releasably held in the first position and/or the second position by other mechanisms (e.g., a detent mechanism, magnets, etc.).

As shown in FIG. 10, the audio output device 10 can mount to various external apparatuses, such as carts, shelves, doors, work benches, boards, pipes, and the like. For example, part of an external apparatus may be received between the flanges 84, 86 and the housing 14 when the carabiner assembly 100 is in the open position. The audio output device 10 thereby hangs from the external apparatus. Since the spring 106 of the carabiner assembly 100 biases the arm 102 toward the closed position, the arm 102 can also provide a clamping force onto the external apparatus. In some embodiments, the carabiner assembly 100 with the arm 102 may be omitted such that the audio output device 10 simply hangs by the flanges 84, 86. In FIG. 10, the audio output device 10 is mounted to a lip 130 of a cart 134 using the carabiner assembly 100. In this scenario, the audio output device 10 clamps to the lip 130 and hangs from the cart 134.

In other scenarios, the audio output device 10 may be hung from a rope, string, cable, or other elongated, flexible object. For example, as shown in FIG. 11A, a rope 138 is threaded through the aperture 92 in the handle 28. As shown in FIG. 11B, the rope 138 is threaded through the closed loop formed by the housing 14, the flanges 84, 86 (or at least one of the flanges 84, 86), and the arm 102. In still other embodiments, the audio output device 10 may be mounted or hung from other types of objects in other ways.

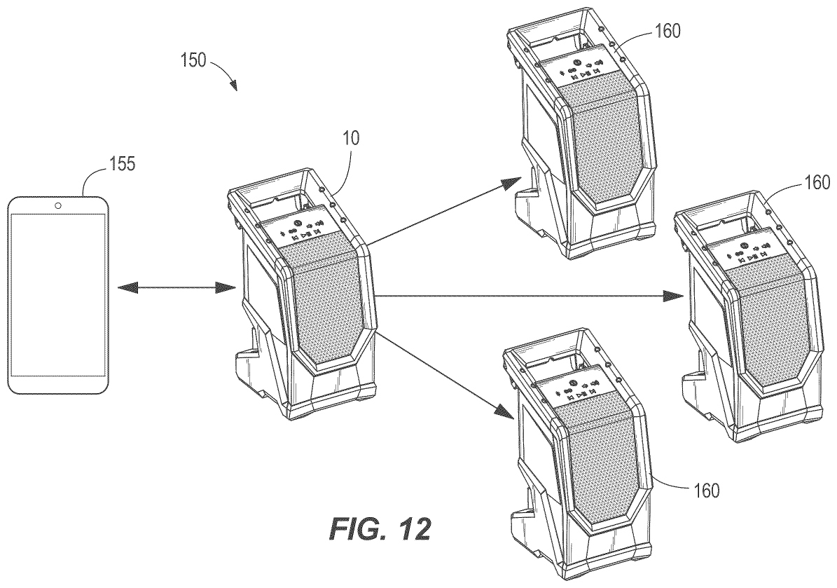

As shown in FIG. 12, the audio output device 10 may be part of an audio output system 150. In the illustrated embodiment, the audio output system 150 is a daisy chain-type system. The audio output system 150 includes the audio output device 10, an audio source 155, and one or more secondary audio output devices 160. The audio source 155 may be a remote device, such as a smartphone, tablet computer, or the like. The audio source 155 is connected to the audio output device 10 to provide audio signals to the audio output device 10. In some embodiments, the audio source 155 may connect to the audio output device 10 through a wireless connection, such as Bluetooth, Bluetooth LE, Wi-Fi, Zigbee, cellular, or other suitable wireless networks. Additionally, the audio source 155 may pair with the audio output device 10 using, for example, the control panel 48 (FIG. 1). Alternatively, the audio source 155 may connect to the audio output device 10 through a wired connection. When connected, the audio output device 10 may output the audio signals through the speakers 20 (FIG. 3). Operations such as play, pause, volume up, volume down, next track, previous track, and the like may be controlled through the control panel 48 on the audio output device 10 or through the audio source 155.

The audio output device 10 may also pass along the audio signals to the one or more secondary audio output devices 160. The secondary audio output devices 160 may have similar constructions and functionality as the audio output device 10 or may be different types of audio output devices. In the illustrated embodiment, the audio output device 10 passes along the audio signals to three secondary audio output devices 160. In other embodiments, the audio output device 10 may pass along the audio signals to any number of secondary audio output devices, such as more than three secondary audio output devices or less than three secondary audio output devices. The audio output device 10 may enter a broadcasting mode (e.g., by interacting with the control panel 48 (FIG. 1)) in which the audio signals from the audio source 155 are passed along to any nearby, compatible secondary audio output devices 160. Similar to the audio source 155, the audio output device 10 may broadcast the audio signals through a suitable wireless network, such as Bluetooth, Bluetooth LE, Wi-Fi, Zigbee, cellular, and the like. In this broadcast mode, the secondary audio output devices 160 do not need to pair with the audio output device 10, but can simply output sound generated by the audio signals. Such an arrangement enhances sound output by allowing multiple audio output devices 10, 160 to be spread throughout a relatively large area (e.g., room) or to be located in different areas (e.g., rooms).

FIG. 13 illustrates a control system 180 of the audio output device 10. The illustrated control system 180 includes a controller 185, a power source (e.g., the battery pack 80), a user interface (e.g., the control panel 48), and a speaker circuit 190. The controller 185 includes a processing circuit 210. The processing circuit 210 may include one or more electronic processors 215 and a memory 220. The electronic processors 215 may be communicably connected to one or more of the user interface, a drive module 200, and a communication interface 205. The electronic processors 215 may be implemented as a programmable microprocessor, an application specific integrated circuit (“ASIC”), one or more field programmable gate arrays (“FPGA”), a group of processing components, or with other suitable electronic processing components.

The memory 220 (e.g., a non-transitory, computer-readable medium) includes one or more devices (e.g., RAM, ROM, flash memory, hard disk storage, etc.) for storing data and/or computer code for completing or facilitating the various processes, layers, and modules described herein. The memory 220 may include database components, object code components, script components, or other types of code and information for supporting the various activities and information structure described in the present application. According to one example, the memory 220 is communicably connected to the electronic processor 215 via the processing circuit 210 and may include computer code for executing (e.g., by the processing circuit 210 and/or the electronic processor 215) one or more processes described herein.

The drive module 200 connects to the speaker circuit 190 to control or drive the one or more speakers 20 (FIG. 3) of the audio output device 10.

The communication interface 205 connects to the audio source 155 and/or the one or more secondary audio output devices 160 (FIG. 12). As noted above, the communication interface 205 may be a wireless communication interface. As such, the communication interface 205 connects to an antenna 225 to send and/or receive wireless signals. The communication interface 205 may include a transceiver and, particularly, a wireless transceiver. In some embodiments, the communication interface 205 may include separate transceivers for communicating with the audio source 155 and with the secondary audio output devices 160. In other embodiments, the communication interface 205 may include a single transceiver for communicating with the audio source 155 and the secondary audio output devices 160. In still other embodiments, the communication interface 205 may include a transmitter that communicates with the secondary audio output devices 160. Additionally or alternatively, the communication interface 205 may include a receiver that communicates with the audio source 155.

The embodiments described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention.

Various features and advantages of the invention are set forth in the following claims.

What is claimed is:

1. An audio output device comprising:
a housing;
a speaker supported by the housing;
a battery receptacle supported by the housing and electrically coupled to the speaker, the battery receptacle configured to receive a battery pack; and
a handle coupled to the housing and having a flange, the flange configured to engage an external apparatus to hang the audio output device from the external apparatus.

2. The audio output device of claim 1, wherein the flange is a first flange, and wherein the handle includes a second flange spaced apart from the first flange.

3. The audio output device of claim 1, wherein the flange is located at a corner of the handle.

4. The audio output device of claim 1, wherein the housing is a cuboid shape defining a top, a base, a front, a back, and two sides, wherein the housing includes a speaker grill extending partially between the top and the front, and wherein the handle extends between the two sides.

5. The audio output device of claim 4, wherein the flange extends from the handle and toward the base.

6. The audio output device of claim 5, wherein a cross-sectional area of the flange decreases as the flange extends from the handle toward the base.

7. The audio output device of claim 1, wherein the handle and the flange define a space to receive the external apparatus.

8. The audio output device of claim 1, further comprising a carabiner assembly coupled to the housing, the carabiner assembly including an arm movable between a first position, in which an end of the arm engages the flange, and a second position, in which the end of the arm is spaced apart from the flange.

9. The audio output device of claim 8, wherein the carabiner assembly also includes a spring coupled to the arm to bias the arm toward the first position.

10. The audio output device of claim 8, wherein when the arm is in the first position, the housing, the handle, and the arm form a closed loop.

11. The audio output device of claim 1, wherein the handle includes an aperture configured to receive a member to hang the audio output device.

12. The audio output device of claim 1, wherein the handle includes a hook recess configured to receive a mounting fastener.

13. The audio output device of claim 12, wherein the hook recess is disposed at a center of the handle.

14. An audio output device comprising:
a housing;
a speaker supported by the housing;
a battery receptacle supported by the housing and electrically coupled to the speaker, the battery receptacle configured to receive a battery pack;
a flange extending from the housing; and
a carabiner assembly coupled to the housing, the carabiner assembly including
an arm movable between a first position, in which an end of the arm engages the flange, and a second position, in which the end of the arm is spaced apart from the flange.

15. The audio output device of claim 14, wherein the carabiner assembly also includes a spring coupled to the arm to bias the arm toward the first position.

16. The audio output device of claim 15, wherein when the arm is in the first position, the housing, the flange, and the arm form a closed loop.

17. The audio output device of claim 15, wherein the flange defines a flange recess configured to at least partially receive the end of the arm when the arm is in the first position.

18. The audio output device of claim 15, wherein the flange is a first flange and the end is a first end, wherein the audio output device further comprises a second flange extending from the housing and spaced apart from the first flange, wherein the arm also includes a second end, and wherein the second end engages the second flange when the arm is in the first position and is spaced apart from the second flange when the arm is in the second position.

19. The audio output device of claim 15, wherein the arm also includes a central portion extending between the first and second ends, and wherein the first and second ends are bent relative to the central portion.

20. An audio output device comprising:
a housing having a top, a base, a front, a back, and two sides, the housing including a speaker grill extending partially between the top and the front of the housing;
a speaker supported by the housing;
a battery receptacle supported by the housing and electrically coupled to the speaker, the battery receptacle configured to receive a battery pack;
a handle coupled to the housing and extending between the two sides of the housing, the handle including a first flange extending toward the base and a second flange spaced apart from the first flange and extending toward the base, the first and second flanges configured to engage an external apparatus to hang the audio output device from the external apparatus; and
a carabiner assembly coupled to the housing, the carabiner assembly including
an arm having a first end and a second end opposite the first end, the arm being movable between a first position, in which the first end engages the first flange and the second end engages the second flange, and a second position, in which the first end is spaced apart from the first flange and the second end is spaced apart from the second flange, and
a spring coupled to the arm to bias the arm toward the first position.
